(19) United States
(12) Patent Application Publication
(10) Pub. No.: US 2015/0208061 A1
(43) Pub. Date: Jul. 23, 2015

(54) THREE-DIMENSIONAL DISPLAY DEVICE

(71) Applicant: Chih-Ming Yang, Shenzhen (CN)

(72) Inventor: Chih-Ming Yang, Shenzhen (CN)

(21) Appl. No.: 14/240,356

(22) PCT Filed: Jan. 21, 2014
(86) PCT No.: PCT/CN2014/070980

§ 371 Date: Feb. 21, 2014

(51) Int. Cl. H04N 13/04; G09G 3/38; G09G 3/36

(52) U.S. Cl. CPC H04N 13/0402; G09G 3/3659; G09G 3/38; G09G 3/3607; G09G 3/3614; H04N 13/0404; G09G 2310/0235; G09G 2310/024; G09G 2320/06; G09G 2320/0613; G09G 2320/0626; G09G 2360/144; H04N 2013/0465; H04N 2213/005

(57) ABSTRACT

The present disclosure proposes a three-dimensional imaging device. The device includes a liquid crystal display for displaying elemental images and a lens array, and light emitted from the liquid crystal display is transmitted through the lens array, wherein, a first device capable of affecting the polarization state of the light and a phase retardation unit are arranged between the liquid crystal display and the lens array, and the light from the liquid crystal display successively passes through the first device and the phase retardation unit and then enters the lens array. The device according to the present disclosure has the advantage that the viewer can receive complete images with a resolution through the twisted nematic liquid crystal cell with high refresh rate.

### FIELD OF THE INVENTION

The present disclosure relates to a three-dimensional display device, which belongs to the technical field of liquid crystal display.

### BACKGROUND OF THE INVENTION

With three-dimensional technologies being widely used in the fields of individual entertainment and domestic digital applications, a Three-dimensional Integral Imaging (3DII) technology serving as one of three-dimensional display technologies has a broad application prospect in the fields of three-dimensional televisions, three-dimensional projection display, medical three-dimensional imaging, virtual and augmented reality and the like. Three-dimensional display technology may present depth information of an object. With same screen size and viewing angle, the quality, brightness perception, depth perception and fidelity of the whole image of a three-dimensional television are much stronger than those of a two-dimensional television.

The three-dimensional display technologies are divided into an eyeglass type three-dimensional display technology and a naked eye type three-dimensional display technology. The former needs wearing of special eyeglasses to experience the three-dimensional effect, while the latter does not need wearing of any eyeglasses to experience the three-dimensional effect, and is also called as a free three-dimensional display technology. For common customers, the price of each pair of eyeglasses is still quite high. Accordingly, in consideration of long-term interests of the customers, research on the naked eye type three-dimensional display technology is particularly important.

A real three-dimensional display technology indicates a 3D display which does not depend on the binocular parallax principle of human eyes, and Integral imaging is one of the real three-dimensional display technologies. Binocular parallax is utilized in most of three-dimensional display technologies at present, and the problems of visual fatigue or poor adaptability and the like may occur after long-time watching. The integral imaging technology can provide a viewing angle of 360 degrees, within which nearly continuously changed parallax can be experienced without the need of auxiliary eyeglasses.

The three-dimensional integral imaging technology is also designated as 3D Integral Photography (3DIP), and as a new method of all-true three-dimensional optical imaging, has become a research focus in the fields of multi-parallax three-dimensional imaging and display. The three-dimensional integral imaging technology has the advantages of elimination of special eyeglasses and coherent light sources, full parallax, continuous viewpoints, good compatibility with existing high-definition television systems etc.

The structure of the Conventional Integral Imaging (CII) system includes a recording microlens array, a relay lens, a charge-coupled device (CCD), a display microlens array, a display device and the like. Generally, the resolution of a reconstructed image is one of the important indices for judging the performance of the three-dimensional integral imaging system, which is affected by each parameter of the system, such as pore sizes and duty ratios of the lens arrays, resolutions of the CCD and the display device etc. A microcell image can only be detected and displayed with a high enough resolution, as a result of which the pixel sizes of recording and display devices become an important factor for determining the resolution of the reconstructed three-dimensional image.

The principle of integral imaging is shown in FIG. 1, wherein the recording and representing process is finished through the following steps. A space scene, namely target 2, is acquired by means of a microlens array 1, which records information of a part of the scene (namely target 2) from different directional angles, and each lens correspondingly generates an elemental image 3, located at an image sensor 4, with a different directional viewing angle. Processed 3D data 6 are then obtained through 3D data processing. The 3D images can be represented merely by a lens array 1′ with the same parameters, and elemental images 3′, located at a display panel 5, can be reconstructed on the basis of the principle of optical path reversibility. Finally, 3D images 2′ are obtained with continuous parallax.

Refer to FIG. 2. During integral imaging, a viewing zone is defined as where a viewer can view an image with complete resolution, and the size of the viewing zone depends on the width D of a cross section at a specific distance from the display and a complete emergence angle of the lens array 1′.

$$Ω = 2 {tan}^{- 1} ( \frac{p}{2 g} )$$

Wherein, p is the diameter of a lens, g is the distance between the lens array and the elemental image, and the viewing angle of integral imaging is determined thereby.

FIG. 2 shows the definition of a viewing zone 7. If the viewer is outside the viewing zone 7, for example, in a zone 8, the viewer would receive distorted and bouncing 3D images with image flips, for light emitted from an elemental image 3′ may actually pass through another adjacent lens on the lens array 1′ instead of its originally corresponding lens.

### SUMMARY OF THE INVENTION

As has been discussed previously, if a viewer is outside the viewing zone, the viewer would receive distorted and bouncing 3D images with image flips, for light emitted from an elemental image may actually pass through another adjacent lens on the lens array instead of its originally corresponding lens.

Thus, the present disclosure proposes a new structure, which may be used for increasing integral imaging viewing angles to avoid distorted images.

The present disclosure proposes a three-dimensional imaging device. In embodiment 1, the device includes a liquid crystal display for displaying elemental images and a lens array, and light emitted from the liquid crystal display is transmitted through the lens array, wherein, a first device capable of affecting the polarization state of the light and a phase retardation unit are arranged between the liquid crystal display and the lens array, and the light from the liquid crystal display successively passes through the first device and the phase retardation unit and then enters the lens array.

In embodiment 2 improved according to embodiment 1, the first device cooperates with the phase retardation unit, so that displayed pictures corresponding to odd lines of liquid crystal pixels of the liquid crystal display are normal, but displayed pictures corresponding to even lines of the same are all black, and/or the first device cooperates with the phase retardation unit, no that displayed pictures corresponding to even lines of liquid crystal pixels of the liquid crystal display are normal, but displayed pictures corresponding to odd lines of the same are all black. The problem in the prior art that a viewer would receive the light passing through adjacent lenses instead of its originally corresponding lenses after moving is solved.

In embodiment 3 improved according to embodiment 1 or 2, the first device is configured in a manner that the polarization state of the light passing through the first device stays unchanged when a voltage is applied to the first device, and the polarization direction of the light passing through the first device is subjected to a 90-degree rotation when no voltage is applied to the first device. However, the first device may also affect the polarization of the light in other manners, for example, that a 90-degree rotation on the polarization angle is performed when the voltage is applied, and no change is performed on the propagation of the light when no voltage is applied.

In embodiment 4 improved according to any of embodiments 1 to 3, the phase retardation unit includes a phase retardation plate, and the phase retardation plate does not affect the passing light at the positions corresponding to odd lines of liquid crystal pixels and implements half-wavelength phase retardation on the passing light at the positions corresponding to even lines of liquid crystal pixels, so that the polarization direction of the light rotates for 90 degrees.

In embodiment 5 improved according to embodiment 4, the crystal axis of the phase retardation plate and the polarization direction of the original light emitted by the liquid crystal display form a 45-degree angle.

In embodiment 6 improved according to embodiment 5, the phase retardation unit also includes a polarizing film on the side of the phase retardation plate facing the lens array.

In embodiment 7 improved according to embodiment 6, only the light of which the polarization direction is vertical to that of the original light emitted by the liquid crystal display is allowed to pass through the polarizing film.

In embodiment 8 improved according to any of embodiments 1 to 7, the first device is a twisted nematic liquid crystal cell.

In embodiment 9 improved according to any of embodiments 1 to 8, the refresh rate of the first device is 120 Hz.

In embodiment 10 improved according to embodiment 1, the phase retardation unit includes a phase retardation plate and a polarizing film on the side of the phase retardation plate facing the lens array, the phase retardation plate does not affect the passing light at the positions corresponding to even lines of liquid crystal pixels and implements half-wavelength phase retardation on the passing light at the positions corresponding to odd lines of liquid crystal pixels, so that the polarization direction of the light rotates for 90 degrees, and only the light of which the polarization direction is vertical to that of the original light emitted by the liquid crystal display is allowed to pass through the polarizing film.

In one condition, the light emitted by the liquid crystal display passes through the twisted nematic (TN) liquid crystal cell (first device) applied with a voltage without being affected and then reaches the phase retardation plate. The phase retardation plate does not affect the passing light at the positions corresponding to odd lines of liquid crystal pixels, and implements half-wavelength phase retardation on the passing light at the positions corresponding to even lines of liquid crystal pixels, so that the polarization direction of the light rotates for 90 degrees. However, only the light of which the polarization direction is vertical to that of the original light emitted by the liquid crystal display is allowed to pass through the polarizing film. Therefore, displayed pictures corresponding to even lines of liquid crystal pixels of the liquid crystal display are normal, but displayed pictures corresponding to odd lines of the same are all black, thus the problem in the prior art that the light shifts to adjacent lenses is solved.

In the other condition, when the light emitted by the liquid crystal display passes through the twisted nematic (TN) liquid crystal cell (first device) to which no voltage is applied, the polarization direction of the light rotates for 90 degrees and then the light reaches the phase retardation plate. The phase retardation plate does not affect the passing light at the positions corresponding to odd lines of liquid crystal pixels, and implements half-wavelength phase retardation on the passing light at the positions corresponding to even lines of liquid crystal pixels, so that the polarization direction of the light rotates for 90 degrees. However, only the light of which the polarization direction is vertical to that of the original light emitted by the liquid crystal display is allowed to pass through the polarizing film. Therefore, displayed pictures corresponding to odd lines of liquid crystal pixels of the liquid crystal display are normal, but displayed pictures corresponding to even lines of the same are all black, thus the problem in the prior art that the light shifts to the adjacent lenses is solved.

With the twisted nematic (TN) liquid crystal cell (first device) refreshed with voltage, the viewer can receive a complete full-pixel picture based on the duration of vision.

The device according to the present disclosure has the advantage that the viewer may receive complete images at a resolution through the twisted nematic (TN) liquid crystal cell (first device) with high refresh rate. Meanwhile, designs of multi-task in space and multi-task in time are integrated using a half-wave plate pattern retarder with specific patterns and a twisted nematic (TN) liquid crystal cell with high refresh rate respectively. In this way, the displayed picture is maintained as a full-pixel picture and the viewing angle of the three-dimensional display is also increased at the same time.

The above-mentioned technical features may be combined in various technically feasible manners to generate new embodiments, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 shows a schematic diagram of the principle of three-dimensional integral imaging;

FIG. 2 shows a viewing zone of a three-dimensional integral imaging device and a zone of a reconstructed image in the prior art;

FIG. 3 shows a state of a three-dimensional imaging device according to the present disclosure that odd lines are all black;

FIG. 4 shows a state of the three-dimensional imaging device according to the present disclosure that even lines are all black;

FIG. 5 shows a schematic diagram of state conversion of the three-dimensional imaging device according to the present disclosure.

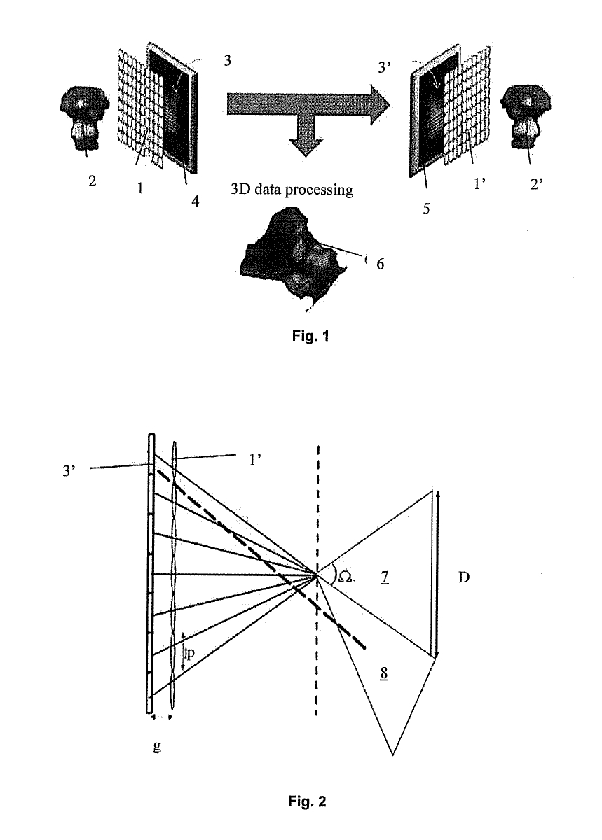

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

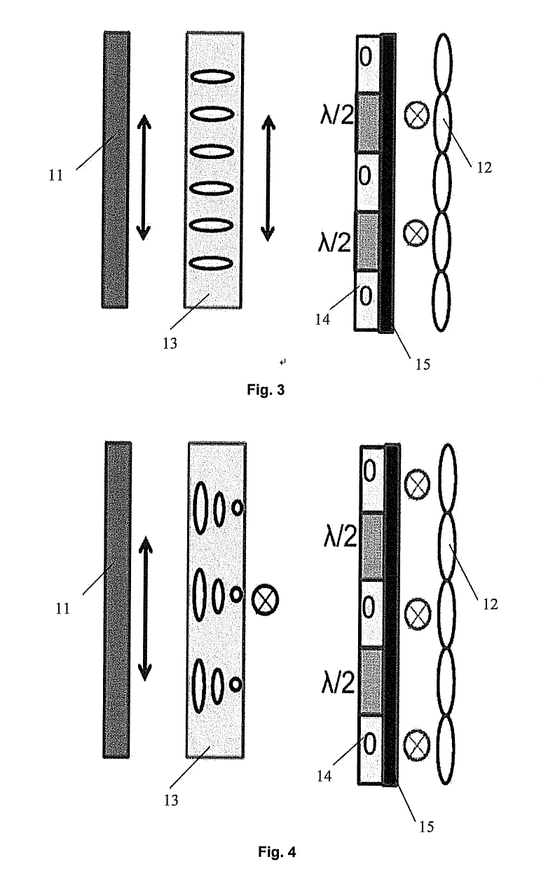

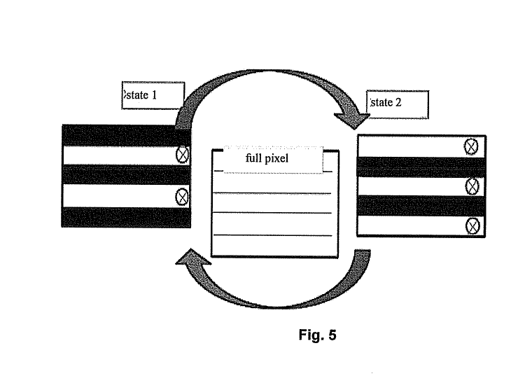

FIG. 3 shows a state of a three-dimensional imaging device according to the present disclosure that odd lines are all black; and FIG. 4 shows a state of the three-dimensional imaging device according to the present disclosure that even lines are all black.

With reference to FIG. 3 and FIG. 4, the present disclosure proposes a three-dimensional imaging device. The device includes a liquid crystal display 11 for displaying elemental images and a lens array 12, and light emitted from the liquid crystal display 11 is transmitted through the lens array 12.

Wherein, a first device 13 capable of affecting the polarization state of light and a phase retardation unit are arranged between the liquid crystal display 11 and the lens array 12, and the light from the liquid crystal display 11 successively passes through the first device 13 and the phase retardation unit and then enters the lens array 12. The light finally enters a display zone and is viewed by a viewer.

The first device 13 is a twisted nematic liquid crystal cell. With reference to FIG. 3 and FIG. 4, the first device 13 is constructed in a manner that the polarization state of the light passing through the first device 13 stays unchanged when a voltage is applied to the first device 13, and the polarization direction of the light passing through the first device 13 is subjected to a 90-degree rotation when no voltage is applied to the first device 13. The refresh rate of the first device 13 can be 120 Hz.

With reference to FIG. 3, in order to solve the problem in the prior art that the viewer receives the light passing through adjacent lenses instead of its originally corresponding lenses after moving, the three-dimensional display device of the present disclosure is configured as follows.

The first device 13 (such as the TN liquid crystal cell) cooperates with the phase retardation unit, so that displayed pictures corresponding to odd lines of liquid crystal pixels of the liquid crystal display 11 are normal, but displayed pictures corresponding to even lines of the same are all black, and/or the first device 13 cooperates with the phase retardation unit, so that displayed pictures corresponding to even lines of liquid crystal pixels of the liquid crystal display 11 are normal, but displayed pictures corresponding to odd lines of the same are all black.

This can be accomplished with the following structural design.

With reference to FIG. 3 and FIG. 4, the phase retardation unit includes a phase retardation plate 14, and the phase retardation plate 14 does not affect the passing light at the positions corresponding to odd lines of liquid crystal pixels and implements half-wavelength phase retardation on the passing light at the positions corresponding to even lines of liquid crystal pixels, so that the polarization direction of the light rotates for 90 degrees.

The crystal axis of the phase retardation plate 14 and the polarization direction of the original light emitted by the liquid crystal display 11 form a 45-degree angle.

The phase retardation unit also includes a polarizing film 15 on the side of the phase retardation plate 14 facing the lens array 12. Only the light of which the polarization direction is vertical to that of the original light emitted by the liquid crystal display 11 is allowed to pass through the polarizing film 15.

With reference to FIG. 3, in a state shown in FIG. 3, the light emitted by the liquid crystal display 11 passes through the twisted nematic liquid crystal cell 13 applied with a voltage without being affected and then reaches the phase retardation plate 14. The phase retardation plate 14 does not affect the passing light at the positions corresponding to odd lines of liquid crystal pixels, and implements half-wavelength phase retardation on the passing light at the positions corresponding to even lines of liquid crystal pixels, so that the polarization direction of the light rotates for 90 degrees. However, only the light of which the polarization direction is vertical to that of the original light emitted by the liquid crystal display 11 is allowed to pass through the polarizing film 15. Therefore, displayed pictures corresponding to even lines of liquid crystal pixels of the liquid crystal display 11 are normal, but displayed pictures corresponding to odd lines of the same are all black, thus the problem in the prior art that the light shifts to adjacent lenses is solved.

With reference to FIG. 4, in a state shown in FIG. 4, when the light emitted by the liquid crystal display 11 passes through the twisted nematic liquid crystal cell 13 to which no voltage is applied, the polarization direction of the light rotates for 90 degrees and than the light reaches the phase retardation plate 14. The phase retardation plate 14 does not affect the passing light at the positions corresponding to odd lines of liquid crystal pixels, and implements half-wavelength phase retardation on the passing light at the positions corresponding to even lines of liquid crystal pixels, so that the polarization direction of the light rotates for 90 degrees. However, only the light of which the polarization direction is vertical to that of the original light emitted by the liquid crystal display 11 is allowed to pass through the polarizing film 15. Therefore, displayed pictures corresponding to odd lines of liquid crystal pixels of the liquid crystal display 11 are normal, but displayed pictures corresponding to even lines are all black, thus the problem in the prior art that the light shifts to the adjacent lenses is solved.

Referring to FIG. 5, with the twisted nematic liquid crystal cell 11 refreshed with voltage, the displayed pictures are continuously converted between the state 1 and the state 2 alternately, and the viewer can receive a complete full-pixel picture based on the duration of vision. The refresh frequency of the twisted nematic liquid crystal cell 13 can be 120 Hz.

The device according to the present disclosure has the advantage that the viewer can receive complete images with a resolution through the twisted nematic liquid crystal cell with high refresh rate. Meanwhile, designs of multi-task in space and multi-task in time are integrated using a half-wave plate pattern retarder with specific patterns and the twisted nematic liquid crystal cell with high refresh rate respectively, no that the displayed picture is maintained as a complete picture and the viewing angle of the three-dimensional display can also be increased at the same time.

However, in other variants of the present disclosure, the phase retardation unit may alternatively include a phase retardation plate 14, the phase retardation plate 14 does not affect the passing light at the positions corresponding to even lines of liquid crystal pixels and implements half-wavelength phase retardation on the passing light at the positions corresponding to odd lines of liquid crystal pixels, so that the polarization direction of the light rotates for 90 degrees, and only the light of which the polarization direction is vertical to that of the original light emitted by the liquid crystal display 11 is allowed to pass through the polarizing film 15.

The first device 13 may also affect the polarization of the light in other manners, for example, that a 90-degree rotation of the polarization angle is performed when the voltage is applied, and no change is performed on the propagation of the light when no voltage is applied.

The pattern of the phase retardation plate 14 and the arrangement on direction of the polarizing film 15 may also be implemented in other manners, as long as the above-mentioned all-black display effect of odd lines or even lines can be achieved.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. A three-dimensional imaging device, including a liquid crystal display for displaying elemental images and a lens array, and light emitted from the liquid crystal display is transmitted through the lens array, wherein, a first device capable of affecting the polarization state of the light and a phase retardation unit are arranged between the liquid crystal display and the lens array, and the light from the liquid crystal display successively passes through the first device and the phase retardation unit and then enters the lens array.

2. The device according to claim 1, wherein the first device cooperates with the phase retardation unit, so that displayed pictures corresponding to odd lines of liquid crystal pixels of the liquid crystal display are normal, but displayed pictures corresponding to even lines of the same are all black, and/or the first device cooperates with the phase retardation unit, so that displayed pictures corresponding to even lines of liquid crystal pixels of the liquid crystal display are normal, but displayed pictures corresponding to odd lines of the same are all black.

3. The device according to claim 2, wherein the first device is configured in a manner that the polarization state of the light passing through the first device stays unchanged when a voltage is applied to the first device, and the polarization direction of the light passing through the first device is subjected to a 90-degree rotation when no voltage is applied to the first device.

4. The device according to claim 3, wherein the phase retardation unit includes a phase retardation plate, and the phase retardation plate does not affect the passing light at the positions corresponding to odd lines of liquid crystal pixels and implements half-wavelength phase retardation on the passing light at the positions corresponding to even lines of liquid crystal pixels, so that the polarization direction of the light rotates for 90 degrees.

5. The device according to claim 4, wherein the crystal axis of the phase retardation plate and the polarization direction of the original light emitted by the liquid crystal display form a 45-degree angle.

6. The device according to claim 5, wherein the phase retardation unit also includes a polarizing film on the side of the phase retardation plate facing the lens array.

7. The device according to claim 6, wherein only the light of which the polarization direction is vertical to that of the original light emitted by the liquid crystal display is allowed to pass through the polarizing film.

8. The device according to claim 7, wherein the first device is a twisted nematic liquid crystal cell.

9. The device according to claim 1, wherein the refresh rate of the first device is 120 Hz.

10. The device according to claim 2, wherein the refresh rate of the first device is 120 Hz.

11. The device according to claim 3, wherein the refresh rate of the first device is 120 Hz.

12. The device according to claim 4, wherein the refresh rate of the first device is 120 Hz.

13. The device according to claim 5, wherein the refresh rate of the first device is 120 Hz.

14. The device according to claim 6, wherein the refresh rate of the first device is 120 Hz.

15. The device according to claim 7, wherein the refresh rate of the first device is 120 Hz.

16. The device according to claim 8, wherein the refresh rate of the first device is 120 Hz.

17. The device according to claim 1, wherein the phase retardation unit includes a phase retardation plate and a polarizing film on the side of the phase retardation plate facing the lens array, the phase retardation plate does not affect the passing light at the positions corresponding to even lines of liquid crystal pixels and implements half-wavelength phase retardation on the passing light at the positions corresponding to odd lines of liquid crystal pixels, so that the polarization direction of the light rotates for 90 degrees, and only the light of which the polarization direction is vertical to that of the original light emitted by the liquid crystal display is allowed to pass through the polarizing film.
